(19) United States
(12) Patent Application Publication
(10) Pub. No.: US 2011/0227507 A1
(43) Pub. Date: Sep. 22, 2011

(54) ILLUMINATION APPARATUS

(75) Inventor: Markus SALM, Heusweiler (DE)

(73) Assignee: GLP GERMAN LIGHT PRODUCTS GMBH, Karlsbad (DE)

(21) Appl. No.: 12/726,669

(22) Filed: Mar. 18, 2010

(51) Int. Cl. H05B 39/00; F21V 21/00; F21V 29/00

(52) U.S. Cl. 315/312; 362/382; 362/294; 362/373

(57) ABSTRACT

Embodiments relate to a illumination apparatus having a mechanical support, a light source, a heat absorption element, thermally coupled and mechanically connected with the light source, a heat dissipation element, which is mechanically connected within the mechanical support. Furthermore, the illumination apparatus has the flexible heat conducting element which is coupled on a first end to the heat absorption element and on a second end to the heat dissipation element, and wherein the flexible heat conducting element is configured to conduct heat from the heat absorption element to the heat dissipation element and to allow a relative movement between the heat absorption element and the heat dissipation element, and a bearing to support the light source so that the light source is movable relative to the mechanical support.

### BACKGROUND OF THE INVENTION

Embodiments of the invention relate to an illumination apparatus for producing light and light effects by a light source encased in a housing and particular to a spotlight. The technical field of the invention is related to the fields of optic in general and particularly to spotlights, also called moving heads. In general, illumination devices of the invention may be used, for example, as stage lights to light up an object, a person, a scenery or for architectural illumination and the like. Furthermore, such spotlights or moving heads may be used for lighting up or creating special optical effects at certain events, such as in theaters, dancehalls, film- or TV-studios and the like.

An illumination apparatus or illumination device may comprise a so-called wash light characteristic. Thereby, a Fresnel lens may be used as projection lens in the illumination device. Such a Fresnel lens may project the light of a light source in a diffuse way and thereby creating the desired wash beam for the illumination apparatus with wash light characteristic. The angle of radiation of a light beam in an illumination apparatus e.g. a common theater spotlight or a moving head can be adjusted from a wide angle characteristic to a narrow angle characteristic.

In common spotlights, often two types of light sources with different mechanical and optical implementations are used. One approach is the use of a halogen light source in a spotlight. Thereby, the halogen light source and a concave reflector are mechanical movably mounted on a guide sled or bearing. A front lens can be fixedly arranged at an open end of the spotlight. As it is schematically shown in the cross-sectional view of a spotlight in FIGS. 1A and 1B, a light source 5 which is arranged in a housing 2 of the spotlight 10 may be movable 16 relative to a fixedly arranged front lens 22 at an open end 2a of the housing 2 of the spotlight 10. By moving the light source 5 relative to the front lens 22, and hence, by changing the distance between the light source 5 and the front lens 22, a change of the angle of radiation a can be achieved. This is schematically shown in FIG. 1B. This means, the angle of radiation angle of the light beam 24 can be changed in dependence on the distance of the light source 5 to the fixedly arranged lens 22.

A further important aspect of an illumination apparatus, e.g. spotlights is the heat generation and the heat dissipation, and hence, the aspect of proper cooling the respective spotlight. For halogen lamps or spotlights a housing made of metal, e.g. sheet metal can be used wherein the size of the housing may be adapted to the heat loss of the light source. This means, proper cooling for such halogen spotlights can be achieved by the usage of a respective large housing made of sheet metal, which releases the dissipation heat of the light source to the environment. In operation the light source gives its dissipation heat or power dissipation to the air volume in the housing and/or directly to the housing. A disadvantage of halogen light sources is the low efficiency, i.e. halogen light sources have a high power dissipation and only a small portion of the power is used to create light. Therefore, cooling of the light source may be a problem. As a further consequence, the cooling of an event location and an undesirable high power consumption of an illumination apparatus may be the problematic. The audience of an event does not want to attend such an event which is heated up to high temperatures by inefficient spotlights. Furthermore, an inefficient waste of electrical power resulting in an unwanted heating of the environment should be avoided for environmental reasons—keyword: carbon footprint.

Another common type of light source for spotlights is a discharge lamp. Arc-lamps comprise a higher power density and a higher color temperature than halogen lamps. Sometimes a halogen lamp is also named tungsten lamp or incandescent lamp. Such Arc-lamps are often used in moving heads. A higher color temperature may be problematic with respect to the natural appearance of the colors, the so-called color rendering index, but for most of the observers a higher color temperature is considered as being brighter, although the measurable brightness is a lot higher. The color rendering index gives a quantitative measure of the ability of a light source to reproduce the colors of various objects faithfully in comparison with an ideal or natural light source. Light sources with a high color rendering index can be desirable in color-critical applications such as photography and cinematography.

The control electronics and the drives for color mixing system in an illumination apparatus, i.e. a moving head or a spotlight can be operated at moderate temperatures only. Therefore, the heat dissipation and the release of the dissipated power again are an important aspect of such discharge lamps used in spotlights or moving heads. For halogen lamps which have a high power dissipation it may cost much effort and expense to cool down the halogen lamp to an acceptable temperature. This means, cooling the halogen lamp may necessitate a high effort in terms of costs and mechanical engineering. Furthermore, fan or ventilators are usually used for cooling and hence, disturbing fan or ventilator noise may develop during operation of the lamps.

Discharge lamps can be cooled more locally precise since the source of the dissipated power is much smaller compared to the halogen sources. Therefore, discharge lamps are clearly less fault tolerant with respect to their operating temperature than halogen lamps. In order to achieve a stable arc, an arc-lamp has to be operated in a narrow temperature range. Therefore, most illumination systems with arc lamps are actively cooled. The light source may be arranged in a cooling air shaft through which the cooling air is blown by means of a ventilator. The most critical point of a discharge lamp is the location where the electrode material is welded to the electrical terminals (the so-called pinch). These locations are precisely cooled in order to avoid an early failure of the light source.

As a consequence, the cooling air flow cannot be steered randomly or diffuse through the illumination apparatus, e.g. the spotlight, but should rather be directed to the most critical points in terms of heat development during operation of the illumination apparatus. Therefore, in an illumination apparatus with a discharge lamp, the discharge lamp is normally not movable in order, e.g. to change the angle of radiation of the illumination apparatus. To achieve the possibility to change the angle of radiation in such an illumination apparatus with a fixedly arranged light source, other optical elements, e.g. a front lens, may be movable. The position of the light source, e.g. the discharge lamp, relative to a heat dissipation element, e.g. openings in a housing, may be unchanged in order not to disturb or change the cooling air flow to the discharge lamp within the housing of the lamp. A disturbance of the directed cooling air flow may cause a overheating of the discharge lamp and hence, a malfunction of the lamp may occur.

There are a couple of possibilities to change the light beam characteristic. In FIGS. 2A and 2B one possibility is schematically depicted. In contrast to the method which has been explained in context with FIGS. 1A to 1B, the light source 5 is fixedly arranged within the housing 2 of a spotlight 10. As it is schematically shown in FIGS. 2A and 2B, a front lens 22 can now be moved 16 relative to the light source 5. As a consequence, the light beam characteristic, e.g. the angle of radiation a can be changed. One of the disadvantages of this approach is that the lens has to be moved in direction to the light source 5 for a wide angle position. This means, the lens 22 is moved into the illumination apparatus or spotlight 10. As a consequence, the maximum light beam angle or angle of radiation a is limited by the dimension of the front opening 2a of the housing 2. A further disadvantage of this approach is that the movable lens 22 may not air-tight seal the apparatus. As a consequence, dirt or dust may come into the housing of the apparatus. In addition at a wide angle of radiation position, this means, if the lens is moved into the apparatus, a person can look from the front side into the housing which may be disturbing for a person attending an event.

As it is schematically shown in FIGS. 3A, 3B and 3C, another possibility to change the light beam characteristic or the angle of radiation necessitates a further optical element, for example, a lens with a positive optical refracting power, e.g. a converging lens. If the further optical element 22a is moved 16 between the Fresnel lens 22 and the light source 5, wherein both are fixedly arranged at their positions, the angle of radiation can also be changed, as it is schematically shown in FIGS. 3A to 3C. The light beam 24 can comprise, for example, a narrow, a medium or a wide angle of aperture or shape. If lens 22a is moved toward the Fresnel lens 22, this means, in the wide angle position with a wide angle of radiation, a focal point 23 may develop outside of the illumination apparatus or spotlight. The focal point 23 may be insignificant for the angle of radiation and the brightness of the light beam 24, but it may be not desirable in terms of esthetical appearance of the light beam for an observer. If, for illumination purposes, artificial fog is used during an event, such a light beam with a focal point 23 would not be seen anymore as a massive light beam in the artificial fog—what is not desirable.

A further possibility to change the light beam characteristic can be achieved by the use of e.g. a frost filter, a negative lens or a lens array in order to enlarge the light beam between the light source and a front lens. In FIG. 4A a simplified schematic cross-sectional view of such an arrangement is depicted. Between a fixedly arranged light source 5 and a fixedly arranged front lens 22 an optical element 27 is arranged, which is configured to enlarge the light beam between the light source 5 and the Fresnel lens 22. Furthermore, the optical element 27, which can be, for example, a frost filter, a negative lens, a convex lens or an area of lenses may be movable 16 between the fixedly arranged light source 5 and the fixedly arranged front lens 22. Depending on the exact position between the front lens 22 and the light source 5, the angle of radiation of the light beam 24 can be varied. This means, by moving the optical element along the axis defined by the light beam 24, the angle of radiation of the light beam 24 can be varied continuously. The light beam 24 may comprise, e.g. a narrow shape, a medium-wide angle of radiation, or it can comprise a wide angle of radiation characteristic.

The optical element 27 can be, for example, a diffuser. An optical element 27 which is arranged between the front lens 22 and the light source 5 may, in general, negatively affect the efficiency of an illumination apparatus, since light may be absorbed or deflected by the optical element. The efficiency with an optical element 27 may only be tolerable, if the optical element, e.g. the diffuser 27, is arranged close to the front lens 22. In that, the light losses may be small. If the optical element 27 is positioned further inside of the illumination apparatus much of the light and therewith the light energy may be lost in the inner part of a housing (not shown in FIG. 4A to C). Therefore, these optical elements 27 are often folded out of the light path for a light beam with a narrow angle of radiation characteristic, as schematically depicted in FIG. 4A.

The realization of such an arrangement with a further optical element 27 can be mechanically complex and therefore expensive. Furthermore, the folding of the diffuser in and out of the light beam may be recognized by a person as a “wipe-effect” during operation which is not desirable.

As a consequence, all known spotlights or illumination apparatus and the respective methods to change the angle of radiation comprise different disadvantages, particularly if one takes into account the requirements for a suitable heat dissipation in such an illumination apparatus, e.g. a spotlight or moving head.

### SUMMARY

According to an embodiment, an illumination apparatus may have: a mechanical support; a light source; a heat absorption element, thermally coupled and mechanically connected with the light source; a heat dissipation element which is mechanically connected with the mechanical support; a flexible heat conducting element which is coupled on a first end to the heat absorption element and on a second end to the heat dissipation element, and wherein the flexible heat conducting element is configured to conduct heat from the heat absorption element to the heat dissipation element and to allow a relative movement between the heat absorption element and the heat dissipation element, and a bearing to support the light source so that the light source is movable relative to the mechanical support.

According to embodiments of the present invention there is provided a spotlight comprising a mechanical support, a light source, a heat absorption element which is thermally coupled and mechanically coupled with the light source, a heat dissipation element, which is mechanically connected with the mechanical support, a flexible heat conducting element, which is coupled on a first end to the heat absorption element and on a second end to the heat dissipation element and wherein the flexible heat conducting element is configured to conduct heat from the heat absorption element, to the heat dissipation element and to allow a relative movement between the heat absorption element and the heat dissipation element, and a bearing to support the light source so that the light source is movable relative to the mechanical support.

According to embodiments the illumination apparatus may further comprise a ventilator, which is fixedly directed to the heat dissipation element, so that a cooling air stream creatable by the ventilator directly hits the heat dissipation element. According to embodiments a flexible heat conducting element in the spotlight may be a fluid circuit comprising a flexible tube or hose which is coupled between the dissipation element and the heat absorption element.

According to embodiments of the invention, the light source may be a light-emitting-diode (LED) or a multi-color LED module, which comprises a light source control unit to control a color mixture of a light beam emitted by the multi-color LED module.

According to embodiments of the invention, an angle of radiation of the light beam of the light source of the spotlight can be varied by a movement of the light source on the bearing.

According to embodiments the location of the heat generation in a spotlight can be decoupled from the location of the heat dissipation to the environment, and wherein the light source is movable within the spotlight.

Other elements, features, steps, characteristics and advantages of the present invention will become more apparent from the following detailed description of the preferred embodiments with reference to the attached drawings.

### BRIEF DESCRIPTION OF THE DRAWINGS

Embodiments of the present invention will be detailed subsequently referring to the appended drawings, in which:

FIGS. 1A-1B show schematic cross-sectional views of a halogen light source and a possibility to change the angle of radiation of the light beam;

FIGS. 2A-2B show schematic cross-sectional views of a spotlight with a movable front lens for changing the angle of radiation of the spotlight;

FIGS. 3A-3C show schematic cross-sectional views of a spotlight with a movable lens between a front lens and a fixed light source in order to vary the angle of radiation of the light beam of the spotlight;

FIGS. 4A-4C show schematic cross-sectional views of a spotlight, comprising between a fixed front lens and a fixed light source, a foldable further optical element which is configured to enlarge the light beam of the light source;

FIG. 5 shows a schematic cross-sectional view of an illumination apparatus or a spotlight according to embodiments of the invention;

FIG. 6 shows a schematic cross-sectional view of an illumination apparatus or spotlight according to embodiments of the invention;

FIG. 7 shows a cross-sectional view of an illumination apparatus or spotlight according to embodiments of the invention; and

FIG. 8 shows a further cross-sectional view of an illumination apparatus or a spotlight comprising a fluid circulation system for cooling the light source according to embodiments of the invention.

### DETAILED DESCRIPTION OF THE INVENTION

With reference to the following description of the embodiments of the present invention, it is to be noted that for simplification reasons the same reference numerals will be used in different figures for functionally identical or similarly acting or functionally equal, equivalent elements or steps throughout the description.

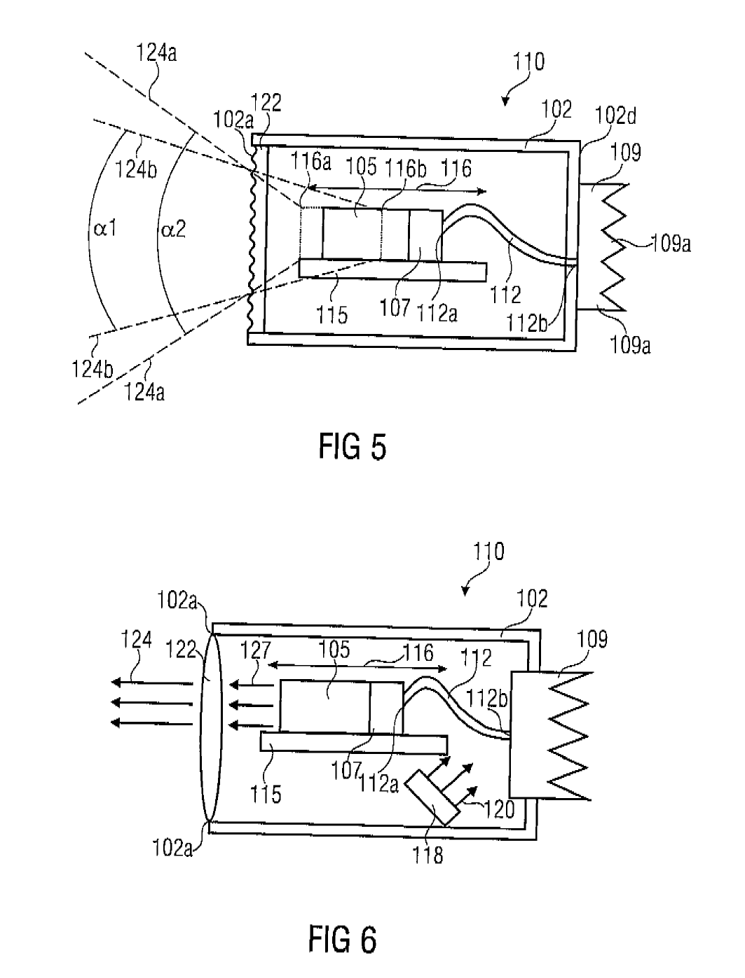

In FIG. 5, a schematic cross-sectional view of an illumination apparatus according to an embodiment of the invention is illustrated. The illumination apparatus can, for example, be a spotlight or a moving head or any other illumination device which can be used, for example, in event technology. In the following, the expression “spotlight” may comprise all possible different illumination apparatus suitable for event technology, e.g. spotlights, moving heads or (beam-) projectors and the like.

A spotlight 110 may comprise a mechanical support 102, a light source 105 and a heat absorption element 107, which is thermally coupled and mechanically connected with the light source 105. The spotlight 110 may furthermore comprise a heat dissipation element 109, which is mechanically connected with the mechanical support 102. A flexible heat conducting element 112, which is coupled on a first end 112a to the heat absorption element 107 and on a second end 112 to the heat dissipation element 109, wherein the flexible heat conducting element 112 is configured to conduct heat from the heat absorption element 107 to the heat dissipation element 109 and to allow a relative movement 116 between the heat absorption element 107 and the heat dissipation element 109. As can be seen in FIG. 5, the spotlight 110 may in addition comprise a bearing 115 to support the light source 105 so that the light source is movable 116 relative to the mechanical support 102. The bearing 115 may be mechanically connected to the mechanical support 102, respectively to the housing 102 of the spotlight 110.

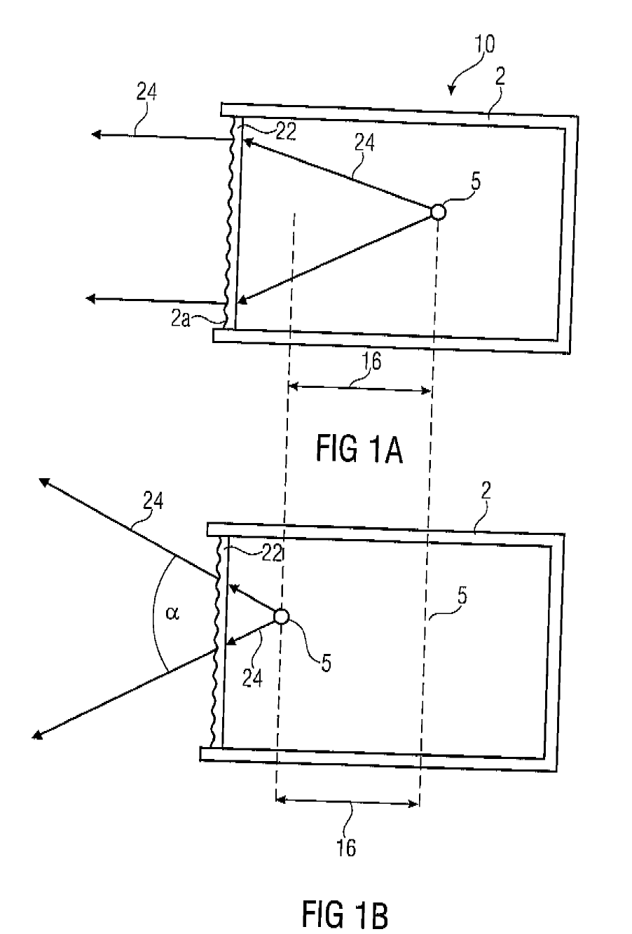

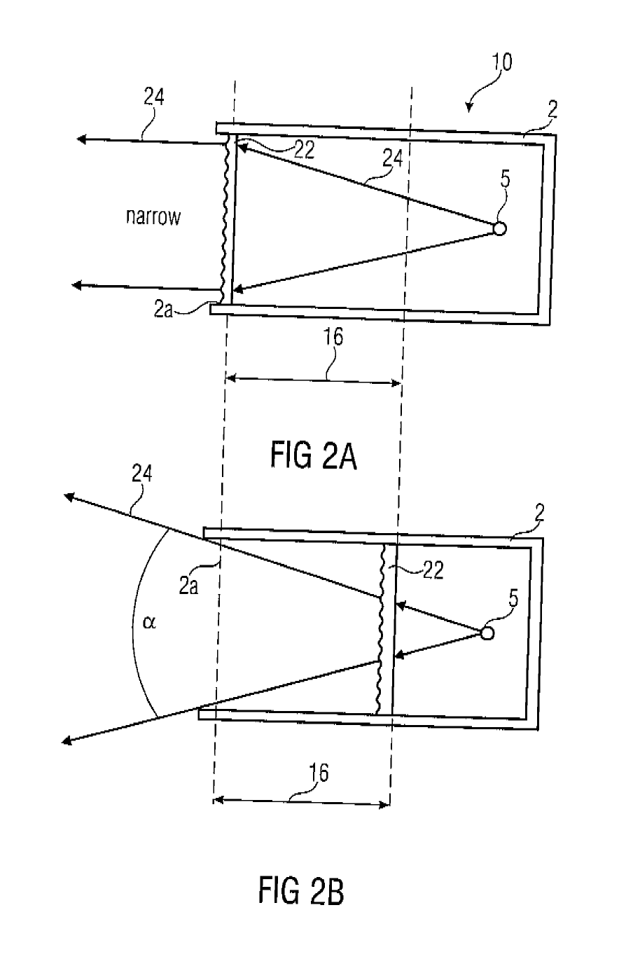

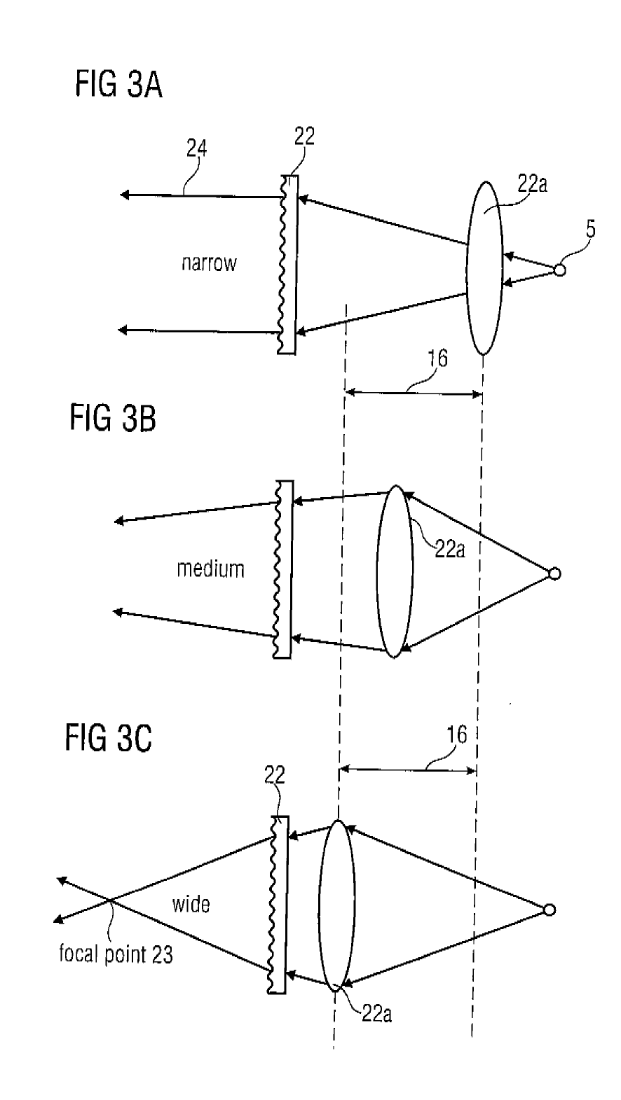

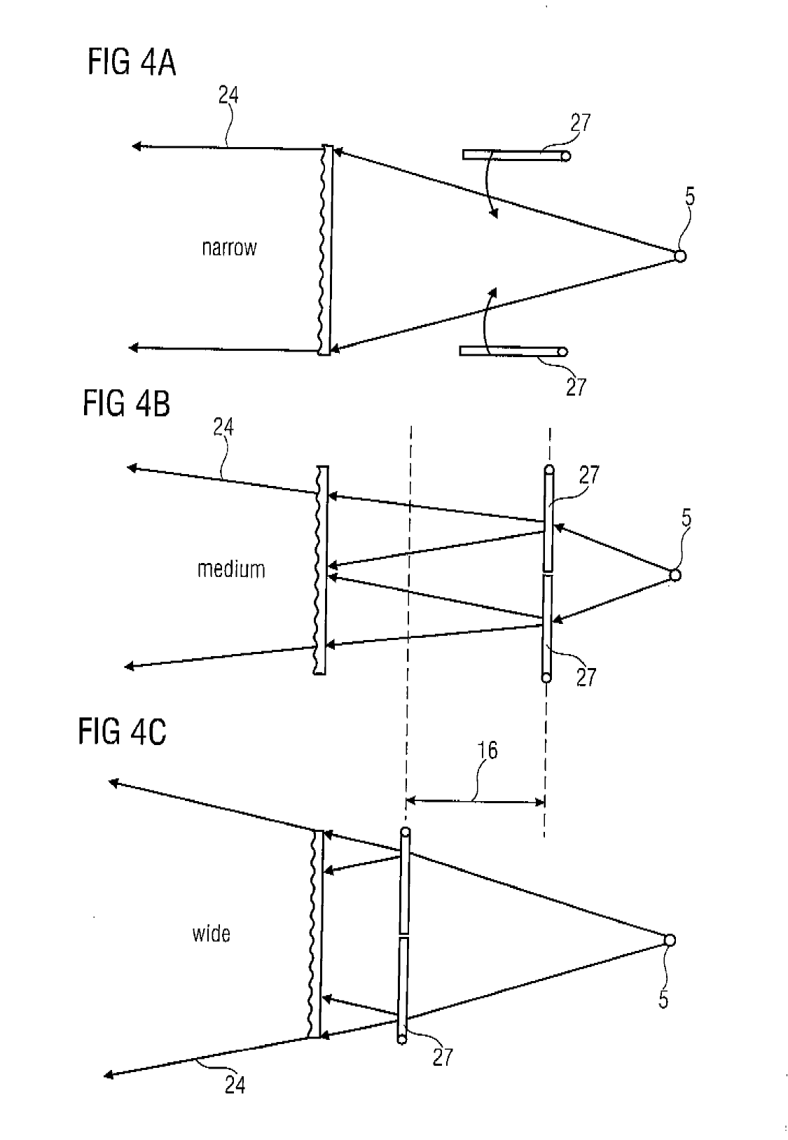

The heat dissipation element 109 may be also mechanically and/or thermally connected at an outer wall 102d of the mechanical support 102. In addition, the heat dissipation element 109 may comprise a plurality of sheets 109a in order to increase the surface of the heat dissipation element so that a more effective heat exchange with the environment can take place. The heat dissipation element 109 may be a radiator. The flexible heat conducting element 112 may be coupled on a second end 112b to the heat dissipation element 109. In embodiments the flexible heat conducting element 112 is configured to decouple the location of the heat generation, e.g. the light source 105 during operation from the location of the effective heat dissipation to the environment, e.g. the heat dissipation element 109. Furthermore, the light source 105 may comprise electrical terminals for power supply (not shown in FIG. 1).

The dissipation heat or the dissipation power can be given off or transported, for example, by thermal conduction, thermal radiation, thermal convection, matter phase transition and that like. The dissipation heat or the dissipation power can be given off indirectly, for example, by thermal radiation, thermal convection, thermal conduction to the housing and the housing can then release the dissipation heat or the dissipation power to the environmental air. The flexible heat conducting element 112 may be, for example, a heat pipe which is configured to conduct the dissipation heat by a matter phase transition.

According to embodiments the light source 105 can be, for example, a discharge lamp, low pressure discharge lamp, a high pressure discharge lamp, a high intensity discharge lamp, a halogen lamp, a xenon-lamp, an incandescent lamp, one or more light-emitting-diodes (LED), a laser or that like. The light emitted from the light source 105 may be a black body radiation and/or it may comprise one or more discrete spectral lines. The emitted light may comprise heat radiation (IR-) and/or visible (VIS-) radiation and/or ultraviolet (UV-) radiation.

According to embodiments, the mechanical support 102 can be a housing of the illumination apparatus 110 or the spotlight. The housing 110 may comprise an open end 102a. During operation of the spotlight 110, the light source 105 may emit light, this means electromagnetic radiation in the visible, in the infrared and/or in the ultra-violet frequency range. The light which is emitted from the light source 105 may comprise a wavelength in the range between 350 nm to 850 nm. During operation of the light source 105, the emitted light beam may leave the housing 102 at the open end 102a of the housing. A dissipation heat or a dissipation power developing during operation of the light source 105 can be transferred or conducted to the heat absorption element 107, which is thermally coupled and mechanically connected with the light source 105. Thermal coupling between the heat absorption element 107 and the light source 105 may be performed in such a way that a heat, which is generated during the operation of the light source, can easily be conducted or transferred to the heat absorption element 107. For thermal coupling a heat-conductive compound may be used. The flexible heat conducting element 112 is thermally coupled on a first end 112a to the heat absorption element 107 and on a second end 112 to the heat dissipation element 109. The flexible heat conducting element and/or a material in the flexible heat conducting element, the heat absorption element and/or the heat dissipation element may comprise a material which is suitable to easily conduct or transfer heat from one location with a higher temperature to a location with a lower temperature. Such a material which can be used could comprise a metal, e.g. copper, silver, gold, aluminum, brass, steel, iron etc. It may also be possible to use a different material with equivalent heat conductivity. The heat absorption element, the heat dissipation element and/or the flexible heat conducting element may comprise a material with a heat conductivity k higher than 3 W/mK, for example, between 10 to 500 W/mK or between 50 to 400 W/mK. In some embodiments the heat conductivity of the flexible heat conducting element 107 may be a quarter of the heat conductivity of copper.

According to embodiments, the flexible heat conducting element 112 can be a flexible tube or a hose for a cooling fluid, wherein the cooling fluid is suitable to cool the heat absorption element. This means, the fluid or coolant may be configured to conduct or transfer the heat from the heat absorption element 107 to the heat dissipation element 109.

The flexible heat conducting element 112 may comprise a bending strength so that a relative movement 116 between the heat absorption element 107 and the heat dissipation element 109 is possible. The length L and the dimension of the flexible heat conducting element 112 may be adapted, so that the heat dissipation element and the heat absorption element can be moved relative to each other. The length L of the flexible heat conducting element 112 may be equal or longer than the distance M the light source 105 can be moved with respect to the housing 102 within the spotlight 110. This means, according to embodiments, the light source 105 which is mechanically connected with the heat absorption element 107 can be moved on a bearing 115 relative to the mechanical support 102, e.g. the housing, without disturbance of the dissipation heat transfer to the heat dissipation element 109. In other words, the light source 105 can be moved within the housing 102 in one direction closer to the open end 102a of the housing 102 and in the contrary direction closer to the closed end 102b of the housing 102 so that the flexible heat conducting element 112 follows this move and a thermal coupling via the flexible heat conducting element with the heat dissipation element 109 is still given. In spite of the movement of the light source the dissipation heat can be effectively transferred to the heat dissipation element 109 which may release the dissipation heat to the environmental air.

The housing 102 can be made, for example, of metal, of sheet metal or at least partly made of plastic or other suitable materials. The movement of the light source 105 on the bearing 115 may be performed manually, by a mechanical drive or, e.g. by means of an electric motor or any other drive suitable to change the position, e.g. to move the light source 105 within the housing 102. The length L of the flexible heat conducting element 112 may be equal or longer than the range of the movement M of the light source within the housing 102.

By means of the flexible heat conducting element, it is possible to separate the location of the generation of the dissipation power, namely the light source during operation and the location for releasing the dissipation power or dissipation heat, namely the heat dissipation element 109, to the environment. According to embodiments of the invention, it is possible, on one hand to continuously move the light source 105, for example, between a first position 116a and a second position 116b within the housing 102, and therewith it is possible to change continuously the angle of radiation from a narrow angle radiation characteristic α1 to a more wide angle radiation characteristic α2. On the other hand, dissipation heat or dissipation power which is generated during the operation of the light source 105 can easily and effectively be transferred or released at each momentary position of the movable light source within the housing 102 by means of the flexible heat conducting element 112 to the heat dissipation element 109. This means, according to embodiments, the advantage of a movable light source 105 within a housing 102 of a spotlight and an easy way to effectively conduct and transfer dissipation power or dissipation heat for cooling reasons from the light source to a heat dissipation element can be combined. From the heat dissipation element 109 the dissipation power may be released to the environment.

According to some embodiments of the invention, there is no movable optical element in the light beam 124 necessary to achieve a zoom-effect of the light beam. This means, for changing the angle of radiation, e.g. continuously from a narrow angle beam position to a wide angle beam position, no additional movable optical element may be needed. This means, according to an embodiment an illumination apparatus 110 does not comprise an optical element for changing an angle of radiation of the light beam 124 and which is movable relative to the light source 105 and which is arranged in the light beam (124) emittable by the light source.

According to embodiments, a movable light source 105 within a housing 102 of a spotlight 110 can be realized, which comprises a simple, effective and inexpensive cooling system based on a flexible heat conducting element 112 which is arranged between the location of the generation of the dissipation heat, namely the light source and a location where the dissipation heat is given off to the environment. Therewith, an effective cooling system for a movable light source in an illuminating apparatus can be achieved, and the advantages of a movable light source with an effective cooling can be combined.

In FIG. 6, a further cross-sectional schematic view of a spotlight 110 according to another embodiment is depicted. According to this embodiment, a spotlight may comprise a fan or ventilator 118, which is fixedly arranged within the housing 102 and fixedly directed to the heat dissipation element 109, so that an air stream 120 which can be generated by the ventilator 118, hits directly the heat dissipation element 109 for cooling the heat dissipation element 109 during operation. By means of the ventilator, the cooling of the light source 105 respectively the release of the dissipation power can be increased.

Since the heat dissipation element is mechanically fixedly connected within the mechanical support 102 (the housing), the ventilator can be fixedly arranged so that the full air stream hits the heat dissipation element 109. This means the light source 105, which is movable 116 relative to or along the x-axis of the spotlight, may not significantly obstruct or disturb the cooling air stream 120. Because of the possibility to arrange the heat dissipation element 109 fixedly at a location of the spotlight 110, it may not be necessary to steer the air stream in a complex way to a heat dissipation element 109 if the light source is movable within the spotlight. The spotlight 110 may comprise a fixedly arranged lens 122, e.g. a Fresnel lens 122 at the open end 102a of the housing 102.

According to embodiments of the invention, the heat dissipation element 109, as it is schematically illustrated in FIG. 6, can be integrated in the housing 102 of the spotlight 110 or it may be fixed at an outer wall 102d of the housing 102. According to embodiments, the lens 122 may be locally fixed at a certain position in the light path 124 of the light source 105. According to an embodiment of the invention, there may be no further optical element arranged in the light path 124 between the lens 122 and the light source 105. According to another embodiment no further optical element which is arranged in the light path 124 between the lens 122 and the light source 105 and which changes or influences the angle of radiation of the light beam 124 is needed.

The lens 122, e.g. a Fresnel lens, may be locally fixedly arranged at the open end 102a of the housing 102, so that the housing 102 is blocked up at the open end 102a by the lens 122. This means, the lens may air-tight seal the opening 120a of the housing, so that dirt or dust cannot get into the inner portion of the spotlight 110. Therewith, dirt at the inner parts, e.g. the light source can be avoided or at least reduced.

According to embodiments of the invention, the lamp, the illuminant or the light source 105 may be one or more light emitting diodes (LED). Such LED may be configured to emit, for example, red, green-, blue-, yellow-, cyan-, white-light, or any other color within the visible spectral range. A light pipe and a lens array may be fixedly arranged in front of a LED. Therefore, a light source may comprise an optical element stationary arranged with respect to the light source. Such an optical element ma ybe part of the light source. The light source 105 may be a multi-colored chip LED module including a plurality of single LEDs which can be controlled by a control unit in order to generate a multi-color light beam 124. This means, the light source 105 can emit light in the whole visible spectral range, e.g. from 350 nm to 850 nm, by combining additive the light output from different LEDs to create a combined multi-color light beam 124. It should be noted that of course the light source 105 may also be able to emit electromagnetic radiation in the infrared and/or in the ultra-violet spectral range. The LED which is used as light source can be a high efficiency LED, or a high efficiency RGB-LED Module, with a current consumption of exemplarily 1 A to 50 A during operation.

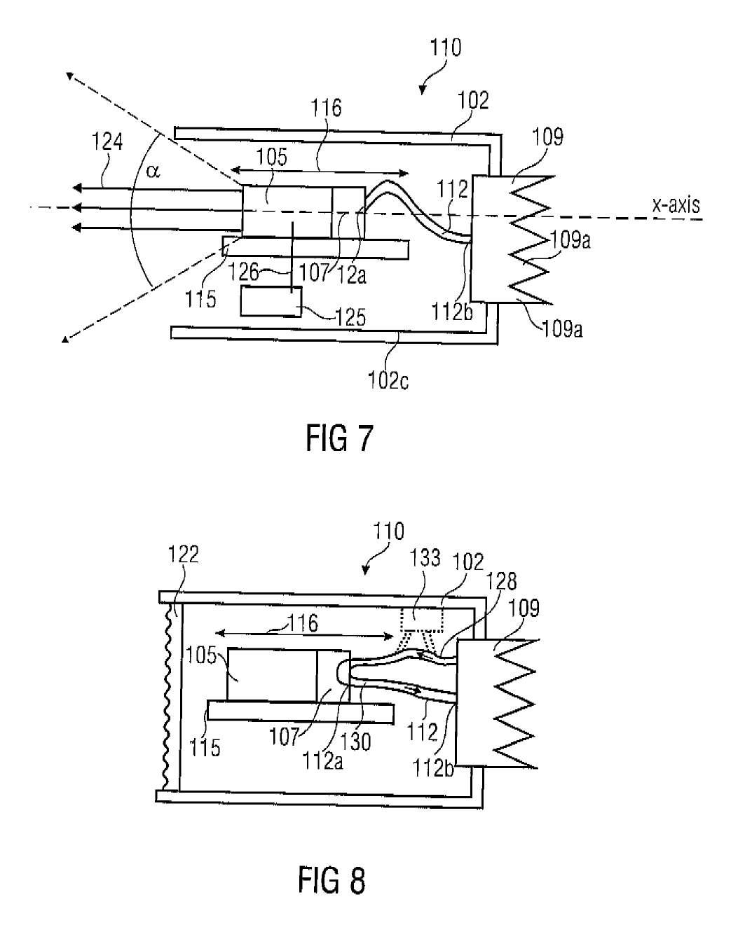

In FIG. 7, a schematic cross-sectional view of a spotlight 110 is shown. The light source 105 can be a multi-color light emitting diode module 105. The multi-color light emitting diode module 105 may be electrically coupled to a light control unit 125. The light control unit 125 may be arranged within the spotlight 110; this means it may be integrated in the spotlight. Alternatively the light control unit 125 may be an external light control unit. The light control unit 125 may be configured to control a color mixture of the light beam 124 of the multi-color LED module. By means of the multi-color LED module, the color mixture of the light beam 124 can be controlled without the usage of a color filter or an optical element, arranged in the light beam 124 of the multi-color LED module. The light control unit may be configured to additive mix the light from different LEDs forming the light source 105.

According to other embodiments, it should be noted that optical filters or other optical elements which can be used to achieve certain optical effects, e.g. wash-beams, gobos etc. are arranged in the light beam 124 of the spotlight. The spotlight 110 may comprise a front lens 122, e.g. a Fresnel-lens 122 (not shown in FIG. 7) which is fixedly arranged at the open end 102a of the housing 102. The multi-color light emitting chip module 105 may be thermally coupled and mechanically connected with the heat absorption element 107. The flexible heat conducting element 112 is coupled on a first end 112a to the heat absorption element and on a second end 112b to the heat dissipation element 109. The flexible heat conducting element 112 is configured to conduct heat from the heat absorption element 107 to the heat dissipation element 109. Furthermore, it is configured to allow a relative movement between the heat absorption element and the heat dissipation element 109. The multi-color chip LED module 105 is movable 116 within the housing 102 of the spotlight 110, for example, along the depicted x-axis, which is schematically shown in FIG. 7. By the movement of the multi-color light emitting diode module 105 along the x-axis, the angle of radiation a of the light beam 124 can be changed. By means of the flexible heat conducting element 112 dissipation heat, which is generated during the operation of the multi-color light emitting diode LED module 105 can be conducted via the heat absorption element 107 to the heat dissipation element 109. The usage of LEDs as light source 105 may have among others the following advantages. A multi-color light beam in the whole visible spectral range can be easily generated by an additive color mixture of different colored LEDs, e.g. red, green, blue and white.

Furthermore, the dimensions of the spotlight 110 which comprises a LED light source 105 as illuminant can be smaller compared to common light sources, like discharge lamps etc. In addition a LED may comprise higher power efficiency and therefore the dissipation heat, which is generated during operation of the spotlight, may be reduced compared to common light sources for spotlights. The angle of radiation a of a spotlight 110 with, e.g. LED light source 105 can easily be changed, as described above. Moreover, power dissipation which is generated during operation of the LED 105 can easily be conducted to the environment by the inventive cooling system, even if the LED light source 105 is moved within the spotlight 110. The cooling system may comprise the heat absorption element 107, the heat dissipation element 109 and the flexible heat conduction element 112. In order to achieve a spotlight 110 with a multi-color light beam 124, no dichromatic-color filters may be necessary any more. Common spotlight make use of dichromatic-filters to achieve a certain color mixture. Such a multi-color light beam 124 may comprise light from the VIS-, IR- and UV-spectral range.

According to embodiments, the spotlight 110 may furthermore comprise other optical elements, for example, a gobo, made of metal or glass, an iris, a prism, a shutter or a strobe. A desired angle of radiation of the light beam 124 from the light source 105 can be adjusted by moving 116 the light source 105 on the bearing 115.

FIG. 8 illustrates in a schematic cross-sectional view of a spot light 110 the usage of a flexible heat conducting element 112 which is configured as a fluid circulation system 112 or cooling circuit 112. The fluid circulation system 112 may comprise a hose or a flexible tube with a fluid 130. The fluid 130 may be a gas or a liquid, e.g. water or oil. The fluid 130 may be configured to conduct the dissipation heat from the heat absorption element to the heat dissipation element 109. The hose or flexible tube may comprise meander-like structures which are arranged in the heat absorption element 105 and/or in the heat dissipation element 109, in order to increase the surface for an effective heat exchange between the fluid 130 and the heat absorption element 107 and/or with the heat dissipation element 109. During operation of the light source 105 the fluid 130 is warmed up at the heat absorption element 107, by absorbing the dissipation heat which is generated by the light source 105 during operation. Then, the heated fluid 30 may flow to the heat dissipation element 109. The heat dissipation element 109 may comprise a lower temperature than the heated fluid 130. Therefore, the heated fluid 130 gives off heat to the heat dissipation element 109 and is thereby cooled down. The heat dissipation element 109 releases the absorbed dissipation heat from the fluid 130 to the environment. Therefore, the heat dissipation element 109 may be kept at a certain temperature which may depend among others on the environmental temperature and the amount of dissipation heat generated by the light source 105 and conducted to the heat absorption element 107.

The fluid 130 then flows back in the cooling circuit 112 in direction to the heat absorption element 107 to absorb there again dissipation heat from the light source 105. This means, the flexible heat conducting element 112 can be a cooling circuit 112 which uses a fluid 130, e.g. a gas or a liquid like water, for cooling the moveable light source 105 in a spotlight 110. The cooling circuit 112 may be configured to work continuously during operation of the spotlight. The transport of the fluid within the cooling circuit from the region of higher temperature, e.g. the heat absorption element 107 to the region of lower temperature, e.g. the heat dissipation element 109, may be achieved by heat convection.

According to another embodiment a pump 133 may be used in order to move the fluid within the cooling circuit 112. The pump 133 may be integrated into the spotlight 110 or it may be an external pump 133. To connect a pump 133, the cooling circuit 112 may comprise cooling terminals which may be, for example, directly integrated in the cooling circuit 112, in the mechanical support or housing 102 or in the heat dissipation element 109. An external pump may than be connected via the cooling terminals to the cooling circuit 112 for moving the coolant 130.

In embodiments the fluid circulation or cooling circuit 112 may be thermally coupled to the heat absorption element 107. The heat absorption element 107 and/or the heat dissipation element 109 may be a heat exchanger which is configured to exchange heat with the fluid of the cooling circuit. The LED light source 105 may be thermally coupled to the heat exchanger 107. By means of a circulating pump 133 the fluid or coolant 130 may be transported via flexible tubes or hoses to the heat dissipation element 109.

The heat dissipation element 109 my act as a radiator which releases the dissipation power by a radiation to the environment. The dissipation element or the radiator 109 may be integrated in the housing 102 or attached to an outer wall 102d of the housing 102. Thus, a good ventilation of the heat dissipation element 109 and the possibility to position the light source 105 within the spotlight 110 as desired can be realized.

Therefore, the position of the light source is not anymore determined by the position for the most effective cooling of the light source 105. Rather, the position of the light source 105 can be chosen by optical reasons, e.g. the light source 105 can be moved within the spotlight at any position in order to achieve a certain desired optical effect. Such a desired optical effect may be, for example, the adjustment of a certain angle of radiation for the light beam 124. The angle of radiation may be changed by a movement of the light source 105 on the bearing 115 within the spotlight.

According to some embodiments the flexible heat conducting element 112 may be a flexible heat pipe. A heat pipe is a heat transfer mechanism that combines the principles of both, thermal conductivity and matter phase transition to efficiently manage the transfer of heat between two chemical interfaces. At the hot interface within a heat pipe, a pressurized fluid 130 in contact with a thermally conductive solid surface, e.g. the surface of the heat absorption element 107, turns into vapor by absorbing the latent heat of that surface. This may result in a phase transition of the fluid 130. The vapor may naturally flow through the heat pipe 112 or cooling system 112 and may condense back into a liquid at the cold interface, e.g. at the heat dissipation element 109, releasing the latent heat. The fluid 130 may then return to the hot interface driven through, e.g. capillary action or gravity action, where it evaporates once more and repeats the cycle. In addition, the internal pressure of the heat pipe 112 can be set or adjusted to facilitate the phase change, depending on the demands of the working conditions of the thermally managed system.

In other embodiments the flexible heat conducting element 112 may comprise at least a quarter of the heat conductivity of copper at room temperature and the heat dissipation element 109 may comprise sheets 109a which are configured to increase the surface of the heat dissipation element 109 for a more efficient dissipation of heat to the environment.

In embodiments the flexible heat conducting element 112 is configured to decouple the location of the heat generation, e.g. the light source 105 during operation from the location of the effective heat dissipation to the environment, e.g. the heat dissipation element 109.

The light source 105 may be an LED light source 105. Such a LED light source may create less dissipation power than halogen a lamp during operation, and it may comprise a smaller power intensity compared to a discharge lamp, since its dissipation power source is larger. Such a LED light source 105 used in the spotlight 110 may be cooled. The cooling can be performed, using, for example, a water cooling system or heat pipes. In general the inventive subject matter allows separating spatially the light source from the location where the dissipation power is generated from the location where the dissipation power is finally released to the environmental air.

According to embodiments of the invention the front lens of the illumination apparatus or spotlight 110 may be fixedly arranged at an open end 102a of the spotlight and the light source 105 which may comprise an LED can be moved in order to affect a change of the angle of radiation of the light beam 124. Advantageously, according to an embodiment other optical elements for changing the light beam 124 need not to be used anymore. The LEDs which are used as light source 105 may be high power and high efficiency LEDs. In general it is desirable to increase the efficiency of such a spotlight or illumination apparatus. Therefore, according to an embodiment of the invention, additional optical elements besides the elements discussed herein for changing the angle of radiation of the light beam 124 may not be needed anymore in a spotlight. This may increase the efficiency of the inventive illumination apparatus, e.g. the spotlight. Furthermore, the weight of such a spotlight and hence, also the costs and the efforts for transporting and manufacturing it, can be reduced according to embodiments of the invention. The thermal load of electronic components which may be arranged within the illumination apparatus 110 can be reduced, since the heat dissipation element 109 or the radiator 109 can be arranged at an outer wall 102d. This means, the dissipation heat can be directly emitted to the environment and does not have to heat up first the inner wall 102c of the illumination apparatus 110. The temperature inside of a spotlight can be reduced compared to a conventional spotlight with an identical electrical power consumption.

As a further consequence, less expensive, more light weight and more environmental friendly materials can be used for manufacturing the mechanical parts of the spotlight 110. Because of the inventive concept to separate the location of the heat generation from the location of the heat dissipation to the environment in a spotlight with a movable light source, the spotlight has not be adapted to withstand very high temperatures according to an embodiment. Because of the inventive concept for cooling the light source within the spotlight, the internal temperature in the spotlight may be reduced compared to the temperature of a common spotlight consuming the same electrical power and hence, a thermal load for the materials and electrical circuits within the spotlight can be reduced.

If the light source 105 is a red-, green-, blue-, white-, multi-color chip LED module, both, the mechanical color mixture by means of a dichromatic-color filter and the usage of a zoom optic may not be necessary anymore. According to an embodiment an illumination apparatus 110 may only comprise a light source, a front lens, e.g. a Fresnel lens and a cooling system as described above. The light source may be movable on a bearing, wherein the movement may be performed mechanically, e.g. manually by a person or by means of a (electric-) motor. According to embodiments the inventive spotlight 110 may save costs, power, reduce weight and save the environmental resources without achieving a lower light quality. This means, the quality and the performance of the light beam 124 which is emitted from the light source 105 of the spotlight 110 may by comparable or even better to light beams emitted by a conventional spotlight. The spotlight 110 may be a wash-light or a projector spotlight.

Moreover, the spotlight 110 may comprise in some embodiments a mechanical or electrical dimmer or a fast mechanical or electrical shutter. In some embodiments of the invention the light beam 124 of the spotlight 110 may comprise a color temperature and an optical power which is comparable or even better than conventional spotlights, using halogen lamps or discharge lamps. The spotlight 110 may consume during operation electrical power, for example, between 50 Watt to 15000 Watt according to some embodiments. The color temperature which can be achieved by means of a spotlight 105 can be, for example, between 4000 K to 8000 K—which is close to daylight.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An illumination apparatus, comprising:
a mechanical support;
a light source;
a heat absorption element, thermally coupled and mechanically connected with the light source;
a heat dissipation element which is mechanically connected with the mechanical support;
a flexible heat conducting element which is coupled on a first end to the heat absorption element and on a second end to the heat dissipation element, and wherein the flexible heat conducting element is configured to conduct heat from the heat absorption element to the heat dissipation element and to allow a relative movement between the heat absorption element and the heat dissipation element, and
a bearing to support the light source so that the light source is movable relative to the mechanical support.

2. The illumination apparatus according to claim 1, further comprising a ventilator, which is fixedly directed to the heat dissipation element, so that an air stream creatable by the ventilator hits the heat dissipation element.

3. The illumination apparatus according to claim 1, further comprising a lens locally fixedly arranged in a light beam of the light source.

4. The illumination apparatus according to claim 3, wherein between the lens and the light source no further optical element is arranged.

5. The illumination apparatus according to claim 3, wherein the mechanical support is a housing of the illumination apparatus and wherein the lens is locally fixedly arranged at an open end of the housing, so that the housing is locked up at the open end by the lens.

6. The illumination apparatus according to claim 1, wherein the mechanical support is a housing of the Illumination apparatus, and wherein the heat dissipation element is integrated in the housing.

7. The illumination apparatus according to claim 1, further comprising a light source control unit and wherein the light source is a multi-color light-emitting diode (LED) module, and wherein the light control unit is configured to control a color mixture of a light beam of the multi-color LED module without the usage of a color filter or an optical element, arranged in the light beam of the multi-color LED module.

8. The illumination apparatus according to claim 1, wherein the flexible heat conducting element is configured as a cooling circuit comprising a flexible tube with a coolant.

9. The illumination apparatus according to claim 1, wherein the flexible heat conducting element is a flexible heat pipe.

10. The illumination apparatus according to claim 1, wherein the flexible heat conductive element comprises at least a quarter of the heat conductivity of copper at room temperature.

11. The illumination apparatus according to claim 1, wherein the heat dissipation element comprises sheets to increase the surface of the heat dissipation element usable for heat exchange.

12. The illumination apparatus according to claim 1, wherein an angle of radiation of a light beam of the light source is variable by a movement of the light source on the bearing.

13. The illumination apparatus according to claim 1, wherein the flexible heat conducting element is configured to decouple the location of the heat generation at the light source from the location of the heat dissipation at the heat dissipation element.

14. The illumination apparatus according to claim 1, wherein the heat dissipation element is fixedly connected with the mechanical support, so that a dissipation heat is directly releasable to the environment.

15. The illumination apparatus according to claim 1, wherein the heat dissipation element which is configured to release a dissipation heat generated by the light source during operation, to the environment, is a radiator which is fixedly connected with an outer wall of the mechanical support, so that the dissipation heat is directly releasable to the environment.

16. The illumination apparatus according to claim 1, wherein no optical element for changing an angle of radiation of a light beam emittable by the light source and which is movable relative to the light source is arranged in the light beam emittable by the light source.
